(19) United States
(12) Patent Application Publication
(10) Pub. No.: US 2022/0154310 A1
(43) Pub. Date: May 19, 2022

(54) HIGH-PERFORMANCE ELASTOCALORIC MATERIALS AND METHODS FOR PRODUCING AND USING THE SAME

(71) Applicants: University of Maryland, College Park, College Park, MD (US); Iowa State University Research Foundation, Ames, IA (US); Colorado School of Mines, Golden, CO (US); The Government of the United States as Represented by the Secretary, Department of Energy, Ames Labo, Ames, IA (US)

(72) Inventors: Ichiro TAKEUCHI, Laurel, MD (US); Jun CUI, Ames, IA (US); Huilong HOU, Greenbelt, MD (US); Valery I. LEVITAS, Ames, IA (US); Ryan T. OTT, Ames, IA (US); Aaron P. STEBNER, Golden, CO (US)

(73) Assignees: University of Maryland, College Park, College Park, MD (US); Iowa State University Research Foundation, Ames, IA (US); Colorado School of Mines, Golden, CO (US); The Government of the United States as Represented by the Secretary, Department of Energy, Ames Labo, Ames, IA (US)

(21) Appl. No.: 17/526,460

(22) Filed: Nov. 15, 2021

Related U.S. Application Data
(60) Provisional application No. 63/113,756, filed on Nov. 13, 2020.

(51) Int. Cl. C22C 14/00; C22C 1/02; C09K 5/12; F25B 21/00

(52) U.S. Cl. CPC C22C 14/00; C22C 1/02; F25B 2321/001; F25B 21/00; C22C 2202/00; C09K 5/12

(57) ABSTRACT

The present disclosure provides stable elastocaloric cooling materials and methods for producing and using the same. Elastocaloric cooling materials of the present disclosure are capable of withstanding 10⁶ cycles. In some embodiments, elastocaloric cooling materials of the present disclosure comprise a mixture of a transforming alloy and a non-transforming intermetallic phase at a ratio of from about 30-70% transforming alloy to about 70%-30% of non-transforming intermetallic phase.

### CROSS-REFERENCE TO RELATED APPLICATIONS

This application claims the priority to U.S. Provisional Application No. 63/113,756, filed Nov. 13, 2020, which is hereby incorporated by reference in its entirety. Because Nov. 13, 2021 is a Saturday and Nov. 14, 2021 is a Sunday, the actual timely filing due date of this Application is the next business day, namely, Monday, Nov. 15, 2021.

### STATEMENT REGARDING FEDERALLY FUNDED RESEARCH

This invention was made with government support under DEAR0000131 awarded by the Department of Energy Advanced Research Projects Agency-Energy (DOE ARPA-E), under MMN1904830 and CMMI1454668 awarded by the National Science Foundation (NSF), and under DEAC0207CH11358 awarded by the Department of Energy (DOE). The government has certain rights in the invention.

### FIELD OF THE INVENTION

The present disclosure relates to high-performance stable elastocaloric cooling materials and methods for producing and using the same.

### BACKGROUND OF THE INVENTION

The first-order transitions of caloric (e.g., magnetocaloric, mechanocaloric, and electrocaloric) materials can be exploited for large cooling effects. Currently, there is an intense interest in elastocaloric cooling as a new alternative solid-state cooling technology. Development of stable and efficient elastocaloric materials offers inter alia a solid-state cooling technology that provides environmentally friendly refrigerators and air conditioners. One of the biggest advantages of caloric cooling devices is that such devices won't leak harmful refrigerants. Conventional gas refrigerants such as chlorofluorocarbons are thousands of times more potent than carbon dioxide as a greenhouse gas.

Elastocaloric cooling, one of the mechanocaloric cooling mechanisms, makes use of the reversible martensitic transformations of shape memory alloys (SMAs) to induce an adiabatic change in temperature, ΔT, (or isothermal change in entropy, ΔS) by absorption and release of transformation enthalpy. With ΔT as large as 17 K and ΔS up to 70 J kg⁻¹ K⁻¹, the energy saving potential of elastocaloric cooling technology has been widely recognized by the community working on non-vapor compression cooling technologies. Functioning elastocaloric cooling prototypes with over 100 W in cooling capacity as well as elastocaloric regenerative heat pumps with temperature span larger than 19 K have been demonstrated. Unfortunately, however, thermomechanical hysteresis that limits the efficiency of their thermodynamic performances as well as their fatigue behaviors remains a concern. Due at least in part to their hysteresis, conventional elastocaloric materials are not suitable for commercial applications.

Therefore, there is a need for high-performance stable elastocaloric materials and methods for producing the same.

### BRIEF SUMMARY

Hysteresis represents work lost in every heat-pumping transformation cycle resulting in dissipated heat. In general, high hysteresis leads to unstable material resulting in early fatigue and failure.

Some aspects of the present disclosure are based on the discovery by the present inventors of processing conditions that allow formation of elastocaloric materials having low hysteresis. Such a low hysteresis results in extremely stable elastocaloric materials.

One particular aspect of the disclosure provides an elastocaloric material comprising titanium-nickel based shape memory alloy having an adiabatic hysteresis area of about 15 MJ m⁻³ or less. In some embodiments, the elastocaloric material comprises at least about 30% per volume of intermetallic phase.

In one particular embodiment, the intermetallic phase comprises TiNi₃.

Still in other embodiments, the elastocaloric material is stable for at least about 100,000 cycles.

Yet in other embodiments, the elastocaloric material has ΔE/E of about 20% or less.

In further embodiments, the elastocaloric material is a nanocomposite material. Without limiting the scope of the invention, in some embodiments, the elastocaloric material is a nanocomposite rod, nanocomposite tube, nanocomposite honeycomb, etc. It should be appreciated, however, the scope of the invention does not limit the shape of the elastocaloric material. It can be of any shape as desired.

Still yet in other embodiments, the elastocaloric material has an isothermal hysteresis area of about 10 MJ m⁻³ or less. In yet other embodiments, the difference in adiabatic hysteresis and the isothermal hysteresis in the elastocaloric material is about 5 MJ m⁻³ or less.

In other embodiments, the elastocaloric material has an effective modulus of at least about 70 GPa.

Another aspect of the disclosure provides an elastocaloric material comprising a mixture of (i) from about 30% volume to about 70% volume of transforming titanium-nickel alloy and (ii) from about 70% volume to about 30% volume of non-transforming titanium-nickel intermetallic phase.

In some embodiments, the elastocaloric material has an adiabatic hysteresis of about 15 MJ m⁻³ or less.

Still in other embodiments, the elastocaloric material is stable for at least about 100,000 cycles.

Yet in other embodiments, the elastocaloric material has ΔE/E of about 20% or less.

Still other aspects of the disclosure provide a method for producing a low-hysteresis elastocaloric material comprising a first and a second metal shape memory alloy, said method comprising:
(a) producing a molten pool of a first metal and a second metal; and
(b) cooling the molten pool at a rate of at least about 500 K s⁻¹ to produce a low-hysteresis elastocaloric material.

In some embodiments, the molten pool of the first metal and the second metal is produced by using a laser-directed-energy deposition (L-DED). It should be appreciated, however, the scope of the invention is not limited to this method of producing molten pool of the first and the second metal. Any method known to one skilled in the art for producing the molten pool of a first and the second metal can be used in methods of this disclosure.

Yet in other aspects of the invention, the elastocaloric material disclosed herein can be produced using, for example, electron beam, shock-compaction, spark-plasma-sintering (“SPS”), or any other method of producing a mixture of transforming and non-transforming (i.e., intermetallic phase) metal alloy mixture. As such, one can produce elastocaloric materials of this disclosure by, for example, admixing a transforming alloy with a non-transforming alloy in a ratio disclosed herein and compacting the mixture to a desired material.

Still in some embodiments, the first metal and the second metal mixture comprises: (a) titanium and nickel; (b) titanium and niobium; (c) titanium and tantalum; (d) titanium and palladium; (e) titanium and gold; (f) nickel and aluminum; (g) nickel and manganese; and (h) iron and palladium.

In further embodiments, the method further comprises the step of heat treating the low-hysteresis elastocaloric material. In one particular embodiment, the step of heat treating comprises heating said low-hysteresis elastocaloric material at a temperature of at least about 650° C. (i.e., 923 K) for at least 3 hours.

Another aspect of the disclosure provides a cooling system comprising an elastocaloric material disclosed herein that is operatively coupled to a mechanical device. When the mechanical device applies a stress to the elastocaloric material, heat generated by said elastocaloric material from said stress is released to one part of said cooling system, and when the mechanical device releases said stress, said elastocaloric material absorbs heat from another part of said cooling system. In this manner, the heat is transferred from one area to another area.

In one particular embodiment, said elastocaloric material used in the cooling system comprises a mixture of (i) from about 30% volume to about 70% volume of transforming titanium-nickel alloy and (ii) from about 70% volume to about 30% volume of non-transforming titanium-nickel intermetallic phase. Still in some embodiments, the non-transforming titanium-nickel intermetallic phase comprises TiNi₃.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic representation of a laser-directed-energy deposition (L-DED) process. Flows of Ni and Ti powders are individually controlled. The Ni and Ti powders are mixed and then fed to the laser beam. An induced molten pool moves to build materials layer by layer with prescribed parameters (Fig. S1).

FIG. 2 is a phase diagram of binary Ti—Ni alloys highlighting the Ni-rich composition near a eutectic point and the molten pool temperature ˜2,073 K. Rapid cooling of the localized molten pool leads to nanocomposite alloys.

FIG. 3 is photographs of L-DED produced nanocomposite in various forms, namely, Ti—Ni rods, tubes, and honeycombs.

FIG. 4 is an SEM image of Ti—Ni alloys of the present disclosure.

FIG. 5 is a bright-field TEM image of Ti—Ni alloys of the present disclosure.

FIG. 6 is a high-resolution HAADF-STEM image of Ti—Ni alloys of the present disclosure.

FIG. 7 is a high-resolution HAADF-STEM image of Ti_{48.5}Ni_{51.5} nanocomposite alloy of the present disclosure.

FIG. 8 is a graph showing substantially fully recoverable behaviors of mechanically pre-treated Ti—Ni nanocomposite alloys of the present disclosure.

FIG. 9 shows stress-strain curves at room temperature of L-DED produced Ti_{48.5}Ni_{51.5} nanocomposite alloys aged at 923 K for 3 hours, where the single arrows denote loading and the double arrows correspond to unloading.

FIG. 10 is a graph showing elastocaloric cooling at room temperature of L-DED produced Ti_{48.5}Ni_{51.5} nanocomposite alloys aged at 923 K for 3 hours, where the double arrows correspond to unloading.

FIG. 11 shows simulated stress-strain curves from a micromechanics model that accounts for the volume fraction of non-transforming phase (insets).

FIG. 12 shows synchrotron X-ray diffraction patterns during in situ loading-unloading.

FIG. 13 shows a graph of determined volume fraction of primary phases at different stress levels during the cycle.

FIG. 14 is a graph showing comparison of stress-strain curves for Ti_{48.5}Ni_{51.5} nanocomposite alloys and melt-cast Ti_{49.2}Ni_{50.8} and Cu₆₈Zn₁₆Al₁₆ alloys at the strain rate of 0.0002 s⁻¹ for isothermal loading/unloading. The area enclosed by the loading/unloading curves represents total dissipation energy per unit volume associated with hysteresis.

FIG. 15 is a graph showing comparison of stress-strain curves for Ti_{48.5}Ni_{51.5} nanocomposite alloys and melt-cast Ti_{49.2}Ni_{50.8} and Cu₆₈Zn₁₆Al₁₆ alloys at the strain rate of 0.2 s⁻¹ for adiabatic loading/unloading. The area enclosed by the loading/unloading curves represents total dissipation energy per unit volume associated with hysteresis. The color code is the same as FIG. 14.

FIG. 16 is a bar graph representation showing comparison of hysteresis area under isothermal and adiabatic loading/unloading as well as the ratio of COPₘₐₜₑᵣᵢₐₗₛ to Carnot COP for L-DED nanocomposite alloys and melt-cast alloys. The color code is the same as FIG. 14.

FIG. 17 is a graph showing the compressive stress-strain stability of Ti—Ni nanocomposite elastocaloric material of the present disclosure.

FIG. 18 is a graph showing the elastocaloric cooling stability of Ti—Ni nanocomposite elastocaloric material of the present disclosure.

FIG. 19 is a log-log plot of the dissipated fraction of input energy, ΔE/E, versus sustained compressive cycles for bulk Ti—Ni nanocomposite elastocaloric material of the present disclosure as well as those reported in the literature. A dissipated fraction of energy is the ratio of hysteresis area, ΔE, in a transformation cycle to the input energy, E. “Lattice-compatible” refers to the alloy where the lattice parameters of transformed and untransformed phases exhibit exceptional lattice compatibility. The straight line is a linear fit. The data from both polycrystalline and single-crystal materials are included.

FIG. 20 is a schematic representation of building an extended thickness in a layer and multiple hatching on the same layer for nanocomposite alloy rods. The dimensionless layer thickness is 6.8, and the inverse of dimensionless hatch spacing is 3.0. The laser beam passes six times on each layer as the hatching angle is changed by 60° with each run. This process results in imparting intense thermal energy, similar to the multiple melting-remelting processes in the conventional melt-casting method.

FIG. 21 is a differential scanning calorimetry thermo-grams of L-DED produced Ni-rich (51.5 at. % Ni) and Ti-rich (47.1 at. % Ni) Ti—Ni nanocomposite alloys after heat treatments (black: Ni-rich, as-built; red: Ni-rich, annealed at 923 K for 3 hours; blue: Ni-rich, annealed at 823 K for 3 hours; green: Ti-rich, as-built), displaying the phase transformation trend near or below room temperature.

FIG. 22 is a plot of austenitic finish temperature, A_{f}, versus endothermic latent heat, ΔH_{M→A}, displaying the wide range of the transformation temperatures and the latent heat.

FIG. 23 is Rietveld refinement on high-resolution synchrotron X-ray diffraction patterns at a stress level of 1,500 MPa to determine the present phases and their volume fractions. TiNi₃, Ti₄Ni₂O, and Ni have a volume fraction of 50.3±0.7%, 5.2±0.3%, and 0.8±0.1%, respectively. At a stress level of 1,500 MPa, TiNi_{B2} and TiNi_{B19′} have a volume fraction of 10.9±0.6% and 33.7±0.6%, respectively. Roughly 50% of the nanocomposite being non-transforming precipitates is consistent with the measured latent heat of 5.6±1.3 J g⁻¹: they would correspond to 14.3±3.3 J g⁻¹ for the transforming fraction (TiNi) of the composite.

FIG. 24 is Rietveld refinement on high-resolution synchrotron X-ray diffraction patterns at a stress level of 0 MPa to determine the present phases and their volume fractions. TiNi₃, Ti₄Ni₂O, and Ni have a volume fraction of 50.3±0.7%, 5.2±0.3%, and 0.8±0.1%, respectively. At a stress level of 0 MPa, TiNi_{B2} has a volume fraction of 43.7±0.6%.

### DETAILED DESCRIPTION

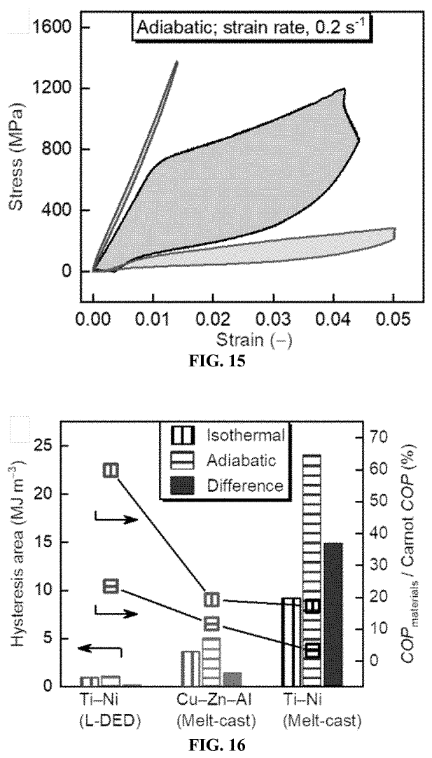

Various aspects of the disclosure are based at least in part on a discovery by the present inventors of low-hysteresis elastocaloric materials and methods for producing the same. As used throughout this disclosure, the term “low-hysteresis elastocaloric material” refers to an elastocaloric material having an adiabatic hysteresis area of about 15 MJ m⁻³ or less, typically about 8 MJ m⁻³ or less, and often about 5 MJ m⁻³ or less. Alternatively, the term refers to an elastocaloric material having an isothermal hysteresis area of about 10 MJ m⁻³ or less, typically about 5 MJ m⁻³ or less, and often about 3 MJ m⁻³ or less. Still alternatively, the term refers to an elastocaloric material having the difference between the adiabatic hysteresis and the isothermal hysteresis of about 5 MJ m⁻³ or less, typically about 3 MJ m⁻³ or less, and often about 2 MJ m⁻³ or less. The values of adiabatic hysteresis and isothermal hysteresis refer to those measured using the experimental conditions disclosed herein. See, for example, FIGS. 15 and 14, respectively.

Throughout this disclosure, unless the context requires otherwise, when referring to a numerical value, the terms “about” and “approximately” are used interchangeably herein and refer to being within an acceptable error range for the particular value as determined by one skilled in the art. Such a value determination depends at least in part on how the value is measured or determined, e.g., the limitations of the measurement system, i.e., the degree of precision required for a particular purpose. For example, the term “about” can mean within 1 or more than 1 standard deviation, per the practice in the art. Alternatively, the term “about” when referring to a numerical value can mean ±20%, typically ±10%, often ±5%, and more often ±1% of the numerical value. In general, however, where particular values are described in the application and claims, unless otherwise stated, the term “about” means within an acceptable error range for the particular value, typically within one standard deviation.

Low-hysteresis elastocaloric materials of the invention include a composition comprising transforming alloy and non-transforming intermetallic phase. In some embodiments, such materials can be made from a mixture including, but not limited to, titanium and nickel; titanium and niobium; titanium and tantalum; titanium and palladium; titanium and gold; nickel and aluminum; nickel and manganese; and iron and palladium. It should be appreciated, however, the scope of the disclosure is not limited to these particular mixtures. In general, the scope of the disclosure includes any mixture that results in a low-hysteresis and/or composition of transforming alloy and non-transforming intermetallic phase as disclosed herein.

For the sake of clarity and brevity, the present disclosure will now be described with regard to the elastocaloric material comprising titanium and nickel, which assist in illustrating various features of the disclosure. However, it should be appreciated that the scope of the disclosure is not limited to elastocaloric materials comprising a mixture of titanium-nickel, but includes those discussed above, as well as other elastocaloric materials that can be readily prepared by one skilled in the art having read the present disclosure. Accordingly, the following discussion of elastocaloric materials comprising titanium and nickel is provided solely for the purpose of illustrating the present disclosure and does not constitute limitations on the scope thereof.

One of the problems of conventional elastocaloric materials is their instability. In particular, it is believed that a high hysteresis of conventional elastocaloric materials is their Achilles heel since it represents work lost in every heat-pumping transformation cycle resulting in dissipated heat. This high hysteresis can ultimately lead to materials fatigue and failure. In fact, this lack of long-life fatigue properties in conventional elastocaloric materials prevents their use in cooling systems.

Surprisingly and unexpectedly, in contrast to conventional understanding of the physical metallurgy of Ti—Ni alloys, the present inventors have discovered that the presence of intermetallic phases is found to be beneficial to elastocaloric performances when they are combined with the binary Ti—Ni compound. Significantly, it was discovered by the present inventors that the resulting microstructure gives rise to quasi-linear stress-strain behaviors with extremely small hysteresis, leading to enhancement in the materials efficiency by a factor of at least five. Furthermore, despite being composed of more than 50% intermetallic phases, the reversible, repeatable elastocaloric performance of this material is shown to be stable over at least about 100,000 cycles, typically at least about 250,000 cycles, often at least about 500,000 cycles, often at least about 750,000 cycles, and most often at least about 10⁶ cycles. Stability of elastocaloric materials can also be defined by the ratio, ΔE/E. As such, in some embodiments, elastocaloric materials of the disclosure have ΔE/E of about 20% or less, typically about 15% or less, often about 10% or less, and more often about 7% or less. The value of ΔE/E refers to that determined using the equation as disclosed herein.

Discovery of stable elastocaloric materials opens the door for direct implementation of additive manufacturing to elastocaloric cooling systems where versatile design strategy enables both topology optimization of heat exchangers as well as unique microstructural control of metallic refrigerants. Accordingly, some aspects of the disclosure provide a cooling system comprising a mechanical device that is operatively connected to elastocaloric materials disclosed herein. The mechanical device provides a force required to exert and release stress or strain to the elastocaloric material, thereby providing heat exchange from one area to another.

In some embodiments, the elastocaloric material is a nanocomposite material. Without limiting the scope of the invention, in some embodiments, the elastocaloric material is a nanocomposite rod, nanocomposite tube, nanocomposite wire, honeycomb-shaped nanocomposite, etc. It should be appreciated, however, the scope of the invention does not limit the shape of the elastocaloric material disclosed herein. In general, elastocaloric materials of the disclosure can be of any shape as desired.

One particular aspect of the disclosure provides a low-hysteresis elastocaloric material comprising a transforming alloy and a non-transforming intermetallic phase. As discussed above, elastocaloric materials of the invention can be produced using a laser-directed-energy deposition (L-DED), electron beam, shock-compaction, spark-plasma-sintering (“SPS”), as well as any other methods that can produce a mixture of transforming and non-transforming (i.e., intermetallic phase) metal alloy mixture. Again for the sake of clarity and brevity, use of an L-DED will be discussed herein. However, it should be appreciated that the scope of the present disclosure is not limited to this particular method of producing elastocaloric materials disclosed herein.

Using an L-DED, metal powders of titanium and nickel are mixed and melted locally and solidified rapidly, to synthesize nanocomposites consisting of transforming, elastocaloric binary Ti—Ni alloy and a non-transforming TiNi₃ intermetallic phase in a two-phase mixture of comparable volume fractions, with intricate dendritic structures. Without being bound by any theory, it is believed that this unique configuration enlists the non-transforming intermetallic phase for biasing the phase transformation leading to considerable improvement in elastocaloric efficiency as well as reversibility of the transformation through minimizing the work hysteresis. It is believed that the presence of this non-transforming intermetallic phase provides a stress transferring mechanism within the elastocaloric materials of the disclosure.

Thus, Ti—Ni alloy elastocaloric materials of the disclosure exhibit substantially reduced hysteresis with a quasi-linear stress-strain behavior resulting in a remarkable five-fold increase in the materials efficiency defined as the ratio of materials coefficient of performance (COPₘₐₜₑᵣᵢₐₗₛ) to Carnot COP. Surprisingly and unexpectedly, it was also discovered that the elastocaloric thermodynamic cycle of these materials is stable over more than a million cycles. In contrast to rate-dependent hysteresis commonly observed in traditionally processed shape-memory alloys (SMAs), the hysteresis of the elastocaloric material of the disclosure is nearly rate-independent (from 0.0002 s⁻¹ to 0.2 s⁻¹), facilitating high-frequency elastocaloric operations.

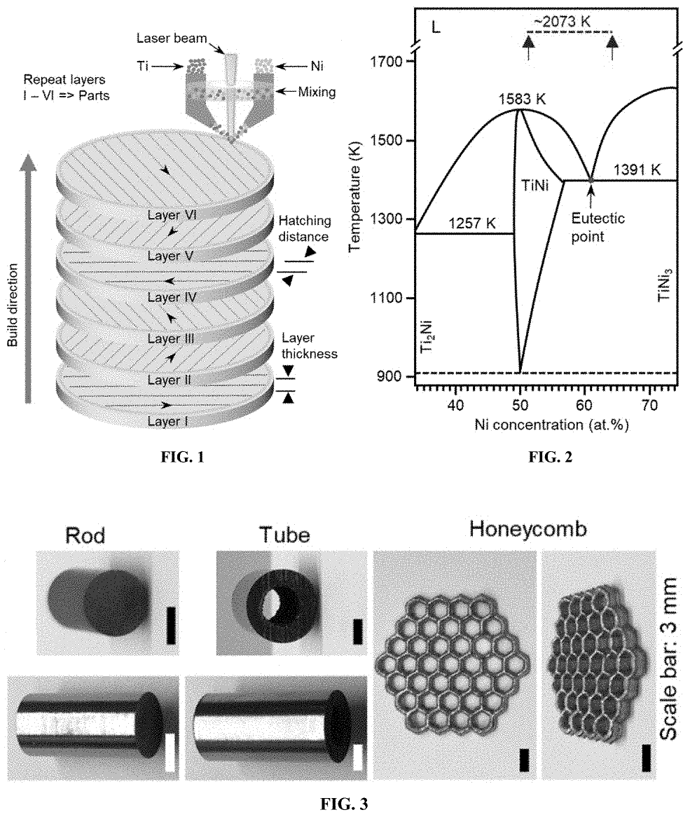

One particular embodiment of the L-DED process is schematically illustrated in FIG. 1. One of the key features of the L-DED process is a millimeter-scale molten pool of mixed powders and a rapid cooling rate of more than 10³ K s⁻¹. Without being bound by any theory, this rapid cooling is believed to provide a stable elastocaloric material of the present disclosure. Metal nanocomposites made by, for example, casting can display a stress-transfer mechanism responsible for high strength, a desirable attribute of functional alloys. Since eutectic solidification can naturally lead to the formation of composites, the eutectic point in the Ni-rich composition range (FIG. 2) of binary Ti—Ni was used to obtain elastocaloric nanocomposite alloys using L-DED. Optimization of processing parameters (such as layer thickness, hatching space) was guided by a normalized processing map for high denseness (≈99%) and mechanical integrity, and the molten pool temperature in operation was maintained to be 1,973-2,173 K, as measured in situ by a ThermaViz pyrometer. Different compositions of Ti—Ni alloys were printed by adjusting the ratio of the flow rate of elemental Ni and Ti powders. FIG. 3 shows some of the printed geometries.

Rapid cooling of the molten pool during L-DED enables precipitation from off-eutectic compositions in a volume fraction comparable to that of eutectic structures. It was observed that a substantial amount of precipitates in a wide compositional range of the Ti—Ni alloys was produced by L-DED (FIG. 2). Curved microstructures can nucleate and grow, because the temperature gradient (highest at center and lowest at periphery) of the molten pool leads to circulation of mass and heat within the pool driven by Marangoni shear stress, thereby creating local perturbations of solute concentration and equilibrium temperature on solid-liquid interfaces and breaking up the plane front in growth of steady-state eutectics. As a result of non-equilibrium conditions, a typical microstructure of L-DED produced Ti—Ni alloys consists of transforming TiNi and non-transforming TiNi₃ phases with large aspect ratios, curved interfaces, and comparable volume fractions (FIG. 4). The size scale of the microstructure was observed to be inversely proportional to the cooling rate, which is at least two orders of magnitude higher in L-DED than that of casting (˜0.1 K s⁻¹) leading to a mixture of two phases at a submicrometer scale (FIG. 5). Accordingly, in some embodiments for producing elastocaloric materials disclosed, the rate of cooling of molten mixture is at least about 5 K s⁻¹, typically at least about 7 K s⁻¹, often at least about 10 K s⁻¹, and most often at least about 15 K s⁻¹.

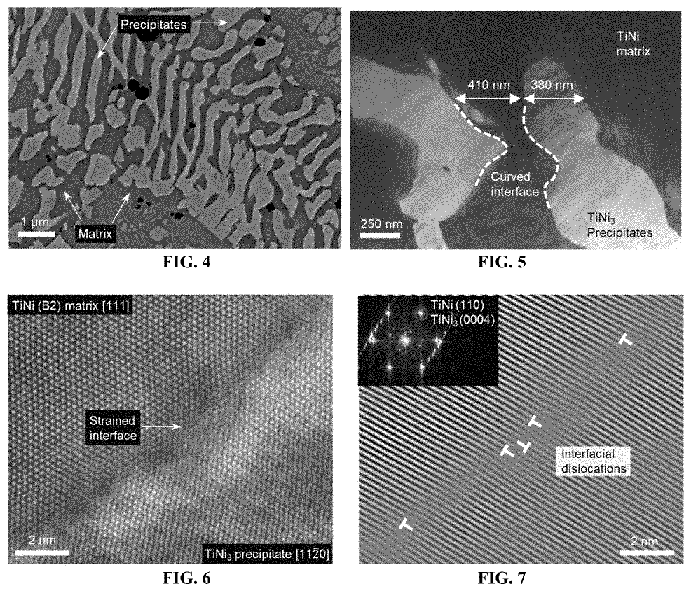

Large curvatures of the interfaces between the cubic B2-ordered TiNi phase and the hexagonal D0₂₄-ordered TiNi₃ phase (FIG. 5) in the nanocomposite microstructures can be naturally accommodated with small lattice mismatches to make their interfaces semi-coherent. An atomic-scale view of the adjacent regions displays strained boundaries (FIG. 6) where interfacial dislocations are located (FIG. 7). Pre-existing sites of high nucleation potency such as dislocations have been reported to trigger atomic shearing for nucleation of martensite where a nucleation energy barrier is lowered (or completely suppressed in the case of spontaneous growth). It is believed that these interfacial dislocations inherent to the curvatures and additional dislocations induced by mechanical pre-treatment (FIG. 8) serve as pre-existing nucleation sites to reduce energy barriers for martensite during the forward transformation and for austenite during the reverse transformation. In addition, these same nucleation sites can act as “micro-pockets” to accommodate remnant austenite and martensite after forward and reverse transformations, respectively, thereby eliminating the necessity of barrier-overcoming stage for nucleation during cyclic loading. After proper self-organization, pre-straining, and pre-stressing (shakedown state, FIG. 8), the intricate nanoscale network of connected microstructure suppresses the dislocation motion and limits transformation dissipation resulting in enhanced cyclic stability.

Accordingly, in some embodiments, disclosed methods further include the step of heat treating the low-hysteresis elastocaloric material. In one particular embodiment, the elastocaloric material is heated to a temperature of at least about 550° C., typically to at least about 600° C., often to at least about 650° C., and most often to at least about 700° C. The amount of time subjected to such a temperature can vary depending on a variety of factors including, but not limited to, the temperature, the nature of the elastocaloric material, size of the elastocaloric material, method of producing the elastocaloric material, etc. However, for Ti—Ni alloy based elastocaloric materials of the disclosure, the amount of heat treatment is at least about 1 hour, typically at least about 2 hours, often at least about 3 hours, and most often at least about 4 hours.

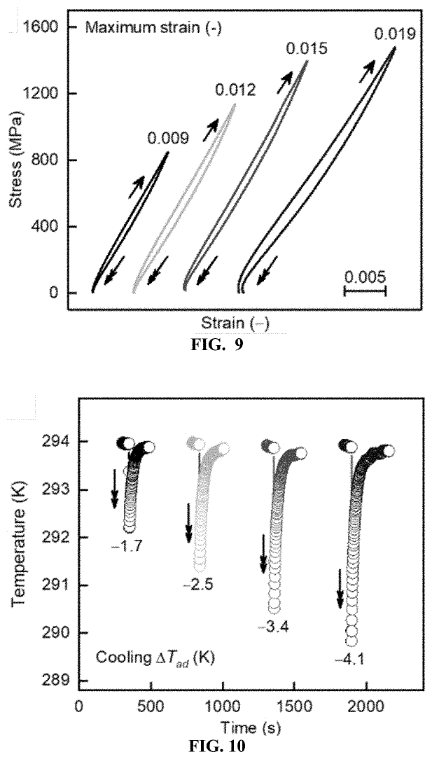

The L-DED nanocomposite alloys exhibit quasi-linear behaviors and substantially reduced hysteresis (FIG. 9). The full strain recovery upon unloading is accompanied by a cooling ΔT_{ad} (FIG. 10), a signature of martensitic transformation, which reaches 4.1 K. Again without being bound by any theory, it is believed that the quasi-linear recovery behavior arises from the load transfer between the non-transforming, stiff intermetallic phase and the transforming non-load-bearing phase. The effective modulus of the L-DED nanocomposite alloys (˜80-90 GPa) is higher than the typical austenite (˜50-60 GPa), i.e., the non-transforming intermetallic TiNi₃ phase is stiffening the alloy. In some embodiments of the disclosure, the elastocaloric material has an effective modulus of at least about 70 GPa, typically at least about 75 GPa, often at least about 80 GPa, and most often at least about 90 GPa.

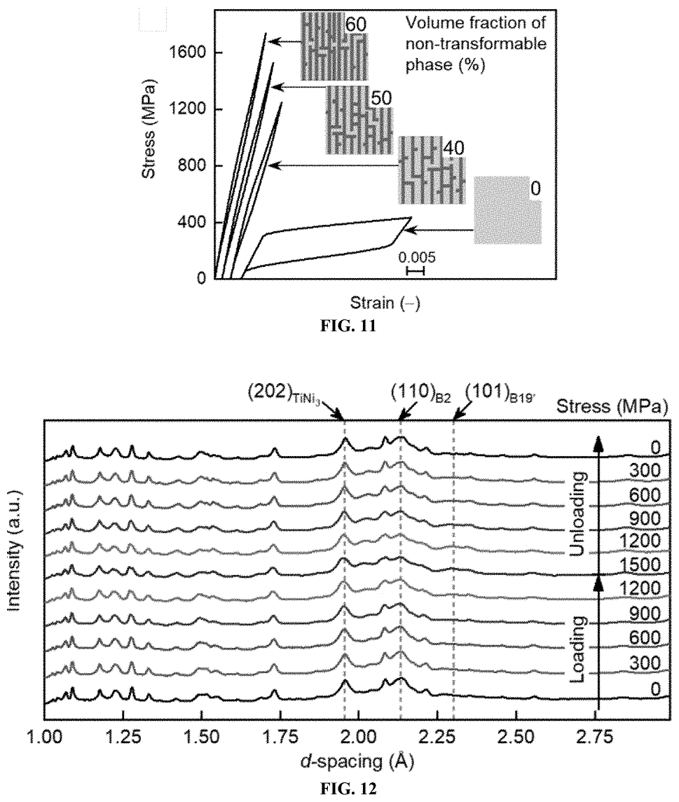

As a result of having higher effective modulus compared to conventional elastocaloric materials, in the disclosed elastocaloric materials as the austenite transforms to martensite, the intermetallic phase continues to carry the load elastically, and the resulting overall behavior is quasi-linear. Simulation of the crossover from a regular superelastic to quasi-linear behavior by varying the volume fraction of non-transforming intermetallic phase and observing the appearance of quasi-linear behavior at a level of 40%, 50%, and 60% was conducted. See FIG. 11.

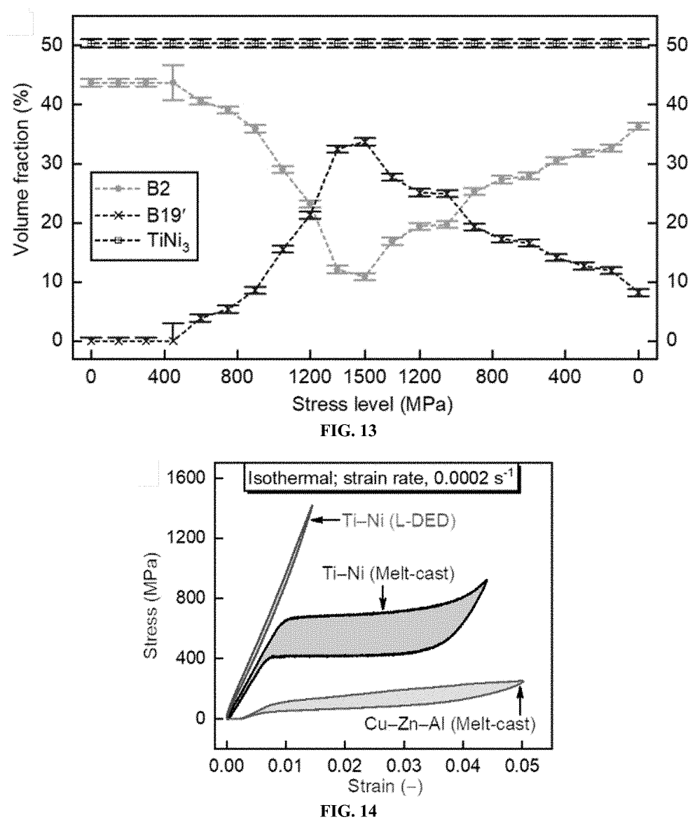

It is believed that the small hysteresis observed here is due to the topology- and defect-controlled kinematics of numerous nucleation events and coalescence, where spatially dispersed pre-existing nucleation sites (FIG. 7) favor continual, heterogeneous nucleation of new martensite followed by their coalescence. The resulting volumetric densities of obstacles that austenite-martensite transformation fronts meet in the course of transformation are reduced and require a decreased amount of frictional work to overcome, as observed in Cu—Zn—Al alloys. Additionally, the intermetallic phase has a large volume fraction (˜50%), and it effectively guides the transformation process through elastic interaction with the transforming phase. This process, in turn, is believed to temper multiple instabilities occurring during traditional nucleation and fast growth and reduces energy dissipation and effective interfacial friction. The progression is captured in in situ synchrotron diffraction measurements as shown in FIGS. 12 and 13.

The commonly-observed rate-dependent hysteresis (e.g., the difference in hysteresis curves between FIGS. 14 and 15) is attributed to transformation-induced heat in SMAs where surface convection dominates heat transfer. From an explicit integral equation of the specific dissipated energy ΔE (which is equal to the generated heat), ΔE can be approximated as:

ΔE≅E_{fr}+ΔT_{ad}·Δs (1)

where E_{fr} is the irreversible specific energy which is the generated heat through interface friction, ΔT_{ad} is the adiabatic change in temperature, and Δs is the specific entropy change associated with the phase transformation. The ΔE during a stress-strain cycle manifests itself as the hysteresis area (divided by density), and it increases with enlarged hysteresis. This relation can also explain the nearly rate-independent hysteresis observed in nanocomposite alloys of the present disclosure (FIG. 16) where thermal conduction (thermal conductivity ≈18 W m⁻¹ K⁻¹) through a large volume fraction of non-transforming phase and surface convection (with convective heat transfer coefficient ≈4 W⁻² K⁻¹) collectively facilitate effective heat transfer and rejection in a transformation cycle. In this instance, the second term on the right of Eq. (1) becomes considerably small due to the rate of heat dissipation approaching the rate of heat generation.

Decreasing E_{fr} contributes to additional reduction in ΔE. In fact, E_{fr} consists of two components: E_{fr}=E_{f}+Eₚ, where E_{f} is the heat dissipated from frictional work in a transformation cycle and Eₚ is the heat dissipated by plastic work within austenite-martensite interfaces due to their coherency loss. Although friction is ubiquitous in the propagation of austenite-martensite interfaces, reducing extended interfacial motions by having uniformly distributed sites for nucleation and coalescence can substantially curtail frictions, leading to reduced E_{f}. The resultant minimization of E_{f} accounts for the substantial reduction in E_{fr} (FIG. 16). In other alloy systems, relaxing local strain energy associated with phase transformation via improving lattice compatibility was found to lead to significant reduction in Eₚ.

Thermodynamics of cooling devices dictates that isothermal loading/unloading in Stirling-like cycles can naturally lead to high efficiencies due to their inherently small hysteresis. However, Stirling-like operation cycles require much longer time per cycle (leading to reduced output wattage) and additional system components for effective heat transfer. In comparison, adiabatic loading/unloading in Brayton-like cycles can operate much faster with relatively simple heat-exchange systems, albeit suffering from lower intrinsic efficiency due to the larger hysteresis (FIG. 15). COPₘₐₜₑᵣᵢₐₗₛ in Brayton-like cycles are governed by the directly measured ΔT_{ad} with the adiabatic hysteresis, and COPₘₐₜₑᵣᵢₐₗₛ materials in Stirling-like cycles are regulated by the latent heat with the isothermal hysteresis, based on a thermodynamically derived equation with full work recovery. In both cycles, the hysteresis of L-DED nanocomposite alloys is extremely small and has a negligible difference (indicating rate-independency). With a Carnot COP=37.5 for Tₕ=308 K and T_{c}=300 K, the ratio of COP materials to Carnot COP of L-DED nanocomposite alloys is approximately 5 times that of melt-cast counterparts (FIG. 16).

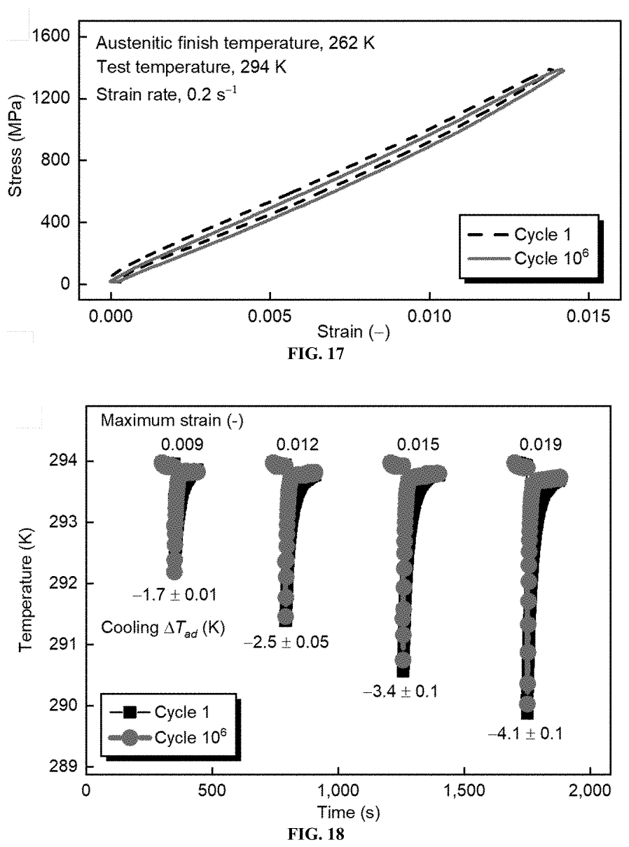

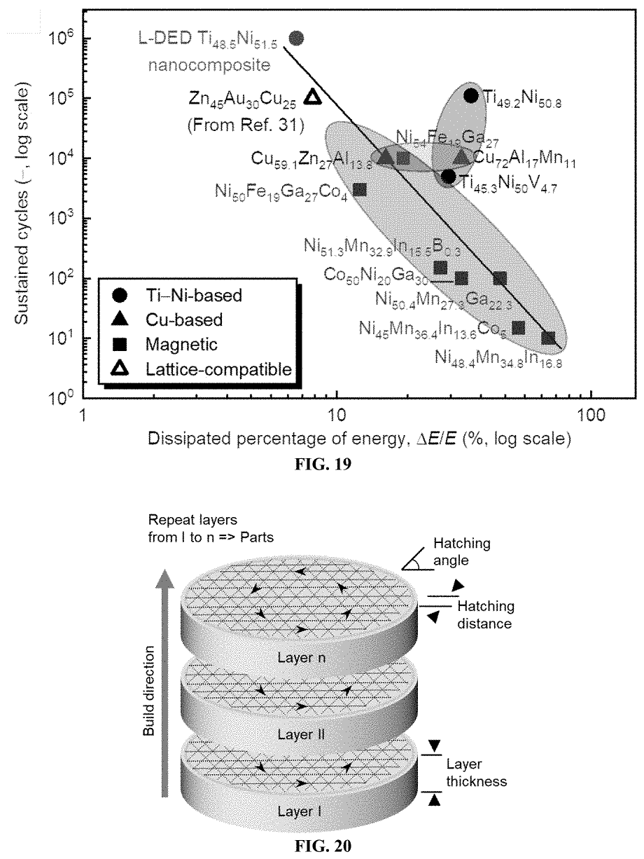

The long-term stability of the elastocaloric materials of the present disclosure can be seen in FIGS. 17 and 18. As can be seen, the elastocaloric materials of the present disclosure are stable in their mechanical behavior and elastocaloric response for over 1 million cycles, indicating that they can be used in regular commercial products with a minimum of typical ten-year life (operating at <1 Hz). Small hysteresis is one important factor responsible for the observed long-term stability of alloys. By tuning the lattice compatibility using stoichiometry in ternary alloys, one can minimize hysteresis of martensitic transformation and improve its reversibility to extended numbers of cycles. However, comparisons of different SMA materials reveal that the absolute value of hysteresis is not the only determining factor. In fact, magnetic SMAs such as polycrystalline Ni—Mn—In and Ni—Fe—Ga seem to deteriorate quickly after a small number of cycles (˜100) even with a hysteresis area as small as 1.2 MJ m⁻³. It is known that for stress-induced fatigue, the endurance limit (that is, the stress amplitude able to attain a prescribed number of cycles, usually 10⁷, at zero mean stress) is proportional to the ultimate strength of materials by a factor of ≈0.33. As can be seen in FIG. 19, across a spectrum of elastocaloric materials, it is the ratio of hysteresis area ΔE, to the input work, E, which seems to determine the number of cycles that the materials can sustain their performance over.

To understand this trend, we consider an analogy to the well-known S-N concept conceived by Wöhler in 1858 that connects the stress amplitude (5) to the cycles to failure (N) in structural fatigue of materials and obtain a correlation of ΔE/E (hysteresis as a fraction of input energy) to the cycles to “functional failure”, N, (which is defined as the number of cycles at the onset of loss of their functionality) in the log—log plot (FIG. 19). In an ideal case of ΔE/E=0 (i.e., transformation with no hysteresis), the number of cycles to functional failure would asymptotically approach infinity. SMAs typically exhibit hysteresis in superelastic cycles; the best compounds hitherto reported for cycling are Zn₄₅Au₃₀Cu₂₅ alloys optimized through tuning the lattice parameters and Ti_{48.5}Ni_{51.5} nanocomposite alloys of the present disclosure with friction-limited kinematics, both of which possess an ΔE/E less than 10%. Because of similarity in the hysteresis behavior associated with input work among different materials, the energy-based (ΔE/E)−N correlation observed here for elastocaloric materials may apply to other caloric materials (i.e., magnetocaloric and electrocaloric materials). Even though the data on fatigue behavior of other caloric materials are somewhat limited, data shown in FIG. 19 indicate that the same correlation holds for them as well. Caloric materials based on first-order transitions with reported low cyclability (e.g., <10,000 cycles) can potentially have their functional fatigue lives extended if their ΔE/E can be decreased by, for instance, materials processing.

Conventionally, it has been believed by one skilled in the art that the presence of non-equiatomic Ti—Ni phases such as TiNi₃ in the TiNi matrix is detrimental to materials integrity as the presence of brittle phases precipitated along grain boundaries can lead to fracture from local stress concentration and mismatch stress generated by transformation-induced shape distortions in neighboring grains. In fact, the non-equiatomic phases have plagued the self-propagating high-temperature synthesis used for porous Ti—Ni for decades as they occur inevitably and produce chemical inhomogeneity in porous implants.

In sharp contrast to a long-held belief, Ti—Ni alloy elastocaloric materials of the present disclosure whose exceptional stability and unusual operational efficiency are in fact derived from their unique and intricate nanocomposite structures made possible by additive manufacturing.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

### Materials and Methods

Materials fabrication: Additive manufacturing of Ti—Ni alloys was carried out by using an L-DED system, Laser Engineered Net Shaping (LENS™) (MR-7, Optomec Inc.) equipped with a 1 kW (1,064 nm wavelength) IPG Yb-fiber laser, four-nozzle coaxial powder feeders, and a motion control system. Two powder feeders were used to separately deliver elemental Ni and Ti powders (size ˜45-88 μm for Ni (purchased from American Elements) and ˜45-106 μm for Ti (purchased from AP&C Advanced Powders & Coatings Inc.); purity >99.9%; gas-atomized) and the rotational speed of each feeder was used to control the mass flow rate of powders in order to tailor the mixing ratio and thus alloy composition. A laser beam with a spot size of 0.5-1.0 mm and a Gaussian intensity distribution created a molten pool on a titanium plate substrate for flowing powders in a high-purity argon environment (<1.0 μL⁻¹ oxygen). A three-dimensional computer-aided design model was used to guide the laser paths of contour and hatch for consecutive tracks on one layer and progressive movement along the Z-direction to generate subsequent layers. Continuous scan strategy was applied with a unidirectional scanning direction. The inverse of dimensionless hatch spacing, which is beam radius divided by hatch spacing, was optimized to be 2.0-3.0 and the dimensionless volumetric energy density (required to melt the powders in a single scan) was tuned to be 1.7-4.3. The varied parameters yielded a sample density of ≈98.9%. Within a 300 mm³ work envelope, cylindric parts were built with dimensionless layer thickness ˜6.8 (FIG. 20) for laboratory tests, while tubular and honeycomb-shaped parts were built with dimensionless layer thickness ˜0.7 as exemplified geometries.

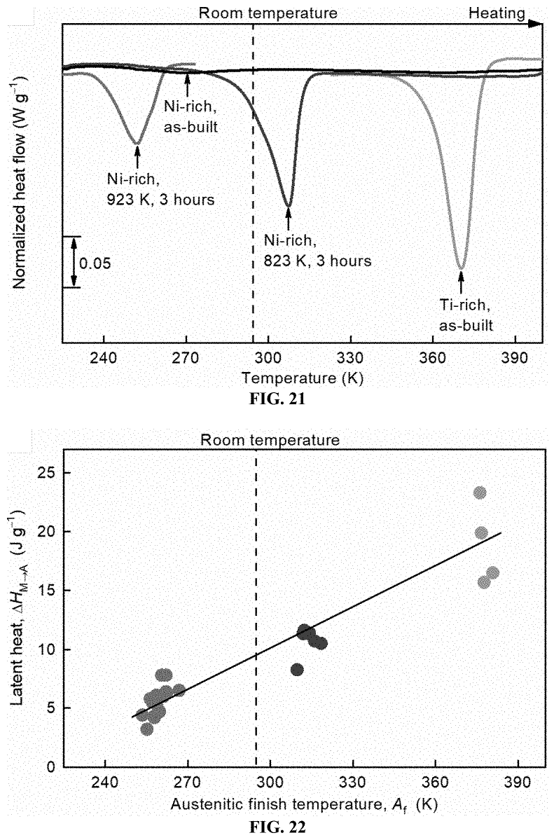

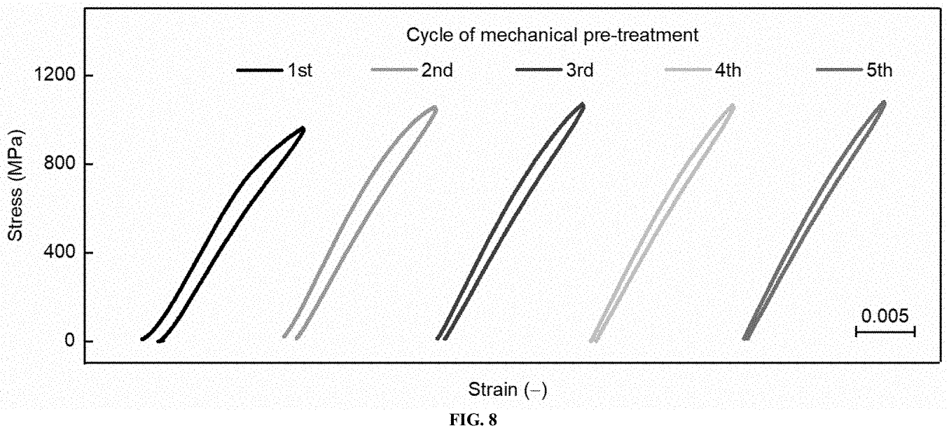

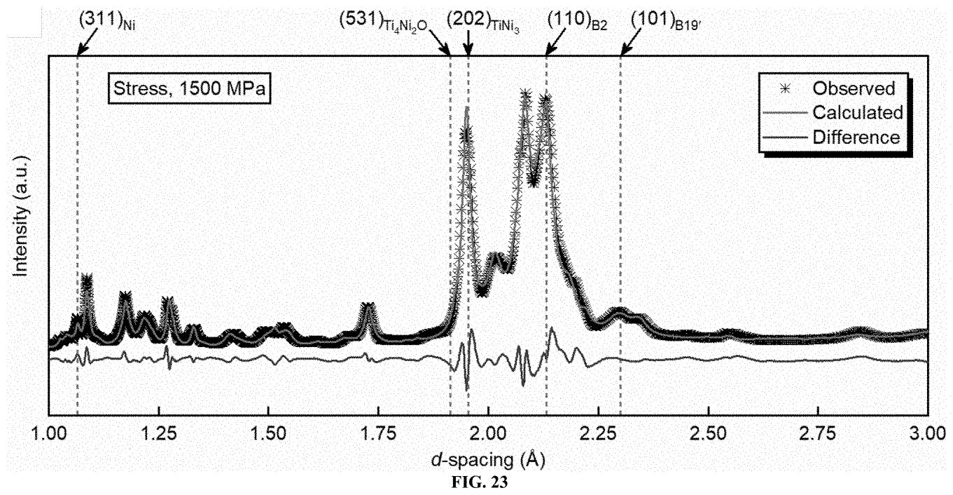

The alloy compositions were characterized using wavelength dispersive spectroscopy (Electron Probe Microanalyzer 8900R, JEOL Inc.) with calibrated standards, after sequential polishing with a final 0.05 μm surface finish. Differential scanning calorimetry (Q100, TA Instruments) was performed at a scanning rate of 10 K min⁻¹ per F2004-05 ASTM standard. Post-fabrication heat treatments were conducted in a high-temperature tube furnace (Lindberg/Blue M, Thermo Fisher Scientific Inc.) at a heating rate of 10 K min⁻¹ under argon environment. FIGS. 21 and 22 show differential scanning calorimetry thermo-grams and a plot of austenitic finish temperature, A_{f}, versus endothermic latent heat, ΔH_{M→A}, of elastocaloric material of the present disclosure. Melt-cast alloys of Ti_{49.2}Ni_{50.8} at. % were purchased from Confluent Medical Technologies Inc. and Cu₆₈Zn₁₆Al₁₆ at. % was synthesized at Ames Laboratory.

Mechanical and elastocaloric cooling testing: Uniaxial compressions were conducted on the machined specimens (10 mm in length and 5 mm in diameter) at room temperature using a servohydraulic load frame (810, MTS Systems Corp.) equipped with a load cell of 250 kN. A factory-calibrated extensometer with a gauge length of 5 mm (632.29F-30, MTS Systems Corp.) was used to record the strains. The temperature of the specimens was measured using T-type thermocouples (nominal size of 0.5 mm×0.8 mm) attached to the middle of the specimens, recorded using a data recorder (cDAQ-9171, National Instruments Corp.), and stored using a LabVIEW program. Mechanical pre-treatment was conducted to initiate fully recoverable behaviors (FIG. 8).

Mechanical cycling tests were performed in a displacement-controlled mode with a sinusoidal loading profile at room temperature. After conversion, the nominal mean strain, εₘ, was set to 2.0% with a strain amplitude, ΔE/2, of 1.8% to keep the specimen subjected to compressive stress throughout the cycles. The cycle frequency was 0.05-0.1 Hz which was about the same as that of operative cycles in cooling system prototypes. 1,000,000 cycles were conducted and then the materials were tested to compare with the initial state.

Microstructure characterization: A focused ion beam microscope (Helios NanoLab G3 UC, Thermo Fisher Scientific Inc.) equipped with a micromanipulator was used to prepare transmission electron microscopy (TEM) specimens by lifting out lamellae along the build direction of the materials and thinning down to ˜100 nm thickness under 30 kV, followed by a sequential cleaning under 5 kV and 2 kV. Scanning electron microscopy (SEM) images were collected at an accelerating voltage of 10 kV and a working distance of 4 mm. TEM observations were performed using a probe-corrected scanning transmission electron microscope (STEM) (Titan Themis 300, FEI Company) operated under an accelerating voltage of 200 kV. High-angle annular dark-field (HAADF) STEM images were acquired in a detection range of 99-200 mrad at a probe convergence angle of 18 mrad, and the dispersive X-ray spectroscopy (EDS) spectra and maps were collected using a Super-X EDS detector.

In situ compression testing during X-ray diffraction: In situ compression testing was performed during synchrotron X-ray diffraction measurements using the third generation Rotational and Axial Motion System (RAMS3) load frame at the Sector 1-ID-E hutch of the Advanced Photon Source (APS) at Argonne National Laboratory. A 1.2 mm wide by 1 mm tall monochromatic X-ray beam with 71.6 keV energy was used to illuminate the gage of the 1×1×2 mm³ parallelepiped compression specimen. During both loading and unloading, at load increments of 150 MPa between 0 and 1,500 MPa compressive loads, diffraction patterns were recorded every 0.5° of sample rotation on a GE-41RT area detector located 1,449.3 mm away from the specimen as the specimen was rotated from 0° to 360° about the loading axis.

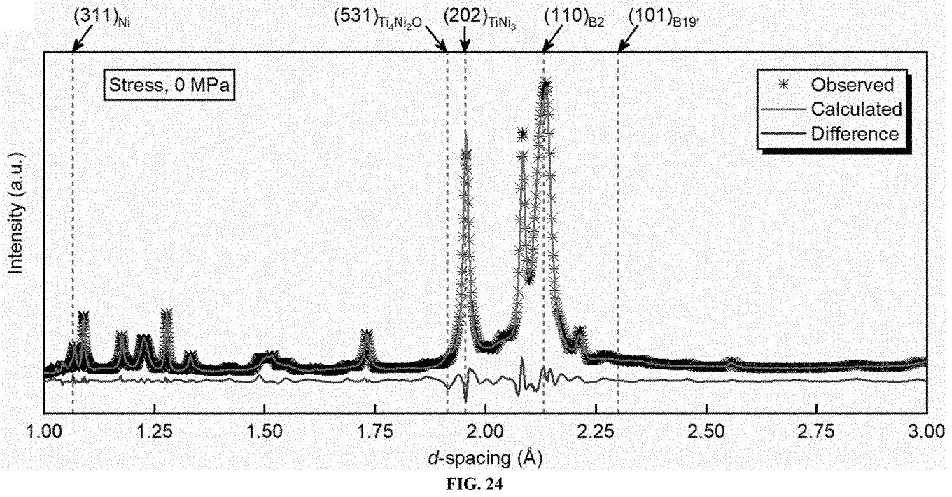

To analyze phase fraction evolutions with loads, all images collected for each load step were summed and integrated into a single histogram, and Rietveld refinement was then performed using GSAS-II. In performing the refinements, the structures of the majority TiNi₃ and B2 phases were firstly used in the refinement model, allowing lattice strains and microstrains to refine for both phases. Despite averaging the diffraction data over all sample rotations about the loading axis, the data still showed signatures of texture, especially for the TiNi₃ phase. This texture is indicative of directional solidification and growth in L-DED processes. Then, sixth and tenth order spherical harmonics functions were used in modeling the B2 and TiNi₃ phases, respectively. After the majority phases were fit, the non-transforming, minority Ni and Ti₄Ni₂O phases were then added to the model. While the lattice strain and microstrain parameters were stable for the Ti₄Ni₂O phase, the microstrain for the Ni phase had to be manually adjusted and fixed. The same refinement strategy was then used for the first four loading steps (150, 300, 450, 600 MPa). The same phase fractions were determined for 0, 150, and 300 MPa loads within a fitting standard deviation. At 450 MPa, the refinement changed, indicating that B2 was transforming to B19′. To fit the martensite phase, the phase fractions of the non-transforming phases were fixed, and the B2 and B19′ phase fractions were refined against each other, in addition to lattice and microstrains for all phases, starting with the peak load (1,500 MPa), and working toward 450 MPa, for both loading and unloading data. The Rietveld model fit to the data for 0 and 1,500 MPa load, including the difference between the measured data and the Rietveld model, is visualized in FIGS. 23 and 24.

Constitutive modeling: Abaqus finite element models of 1×1 mm² size with sectional thicknesses of 0.1 mm were made to mimic the aspect ratios of TiNi versus TiNi₃ morphologies experimentally observed in FIG. 4. The models were meshed using approximately 21,000 4-node doubly curved S4 elements with 0.01 mm size. Elements were assigned to belong to either a transforming TiNi phase or a non-transforming phase, with phase assignments mimicking the observed microstructures as reasonably as possible considering the mesh size. The non-transforming phase was assumed to be a volume-averaged mixture of TiNi₃, Ti₄Ni₂O, and Ni (volume fractions) according to the quantitative analysis of synchrotron X-ray diffraction patterns. More specifically, an equivalent non-transforming phase was defined with the effective Young's modulus, \tilde{E}=0.85×E_{TiNi}_{₃}+0.1×E_{Ti}_{₄}_{Ni}_{₂}_{O}+0.05×E_{Ni} and Poisson's ratio \tilde{ν}=0.85×ν_{TiNi}_{₃}+0.1×ν_{Ti}_{₄}_{Ni}_{₂}_{O}+0.05×v_{Ni}, where the Young's modulus and the Poisson's ratio for TiNi₃, Ti₄Ni₂O, and Ni are 235 GPa, 44 GPa, and 200 GPa, and 0.28, 0.35, and 0.31, respectively. Models made using 40%, 50%, and 60% volume fractions of these non-transforming phases were used in the simulations. The transforming TiNi phase was simulated using the superelastic model that is built into Abaqus with E_{TiNi-B2}=46 GPa, E_{TiNi-B19′}=28 GPa, ν_{TiNi-B2}=0.33, ν_{TiNi-B19′}=0.33, σ_{M}^{s} (start stress for forward transformation into martensite)=300 MPa, σ_{M}^{f} (finish stress for forward transformation into martensite)=500 MPa, σ_{A}^{s} (start stress for reverse transformation into austenite)=250 MPa, of (finish stress for reverse transformation into austenite)=50 MPa, and ε_{L} (transformation strain)=5%.

Thermodynamic analysis: Elastocaloric materials coefficient of performance COPₘₐₜₑᵣᵢₐₗₛ were computed based on the thermodynamic analysis of our custom single-stage elastocaloric testing system, where the elastocaloric materials exhibit a uniform temperature profile at Tₕ (the temperature at hot heat exchanger) and T_{c} (the temperature at cold heat exchanger). The elastocaloric Brayton-like cycle consists of isentropic (adiabatic) loading and unloading processes, and two heat transfer processes under constant stress fields. The elastocaloric Stirling-like cycle consists of isothermal loading and unloading processes, and two heat transfer processes under constant stress fields. By merging thermodynamics-based equations with hysteresis-contained Equation (1), we make a universal form of COPₘₐₜₑᵣᵢₐₗₛ materials in Equation (S1):

$${COP}_{materials} = \frac{{T}_{c} \cdot Δ s - Δ E \text{/} 2}{( {T}_{h} - {T}_{c} ) \cdot Δ s + Δ E} \qquad ( S1 )$$

Here, Δs is computed using Δs=q/T_{c}, where q is the absorbed heat, which can be obtained using ΔT_{ad} as q=Cₚ×ΔT_{ad} with a specific heat capacity Cₚ of 550 J kg⁻¹ K⁻¹ (Ti—Ni) and 420 J kg⁻¹ K⁻¹ (Cu—Zn—Al), or by ΔH_{M→A} via q=ΔH_{M→A}. Materials densities ρ are 6,500 kg m⁻³ for Ti—Ni and 7,700 kg m⁻³ for Cu—Zn—Al. Tₕ and T_{c} are set to be 308 K and 300 K, respectively, to be consistent with AHRI Standard 210/240. Here,

$$Carnot COP = \frac{{T}_{c}}{( {T}_{h} - {T}_{c} )} = 37.5 .$$

Optimization of processing parameters for alloy design.

To optimize process parameters, a recommended processing window in a normalized processing diagram was selected. The dimensionless volumetric energy density, E*, is defined in Equation (S2):

$${E}^{*} = \frac{{p}^{*}}{{v}^{*} \cdot {l}^{*}} = \frac{A \cdot p}{2 \cdot v \cdot l \cdot {r}_{b} \cdot ρ \cdot {C}_{p} \cdot ( {T}_{m} - {T}_{0} )} \qquad ( S2 )$$

where

$${p}^{*} = \frac{A \cdot p}{{r}_{b} \cdot k \cdot ( {T}_{m} - {T}_{0} )}$$

is the dimensionless laser power,

$${v}^{*} = \frac{v \cdot {r}_{b}}{D}$$

is the dimensionless laser scanning speed,

$${l}^{*} = \frac{2 \cdot l}{{r}_{b}}$$

is the dimensionless layer thickness, A is the surface absorptivity (≈0.26) p is the laser power, ν is the laser scanning speed, l is the layer thickness, r_{b} is the beam radius, ρ is the density, Cₚ is the specific heat capacity, Tₘ is the melting temperature, and T₀ is the initial temperature of the material. Besides,

$${h}^{*} = \frac{h}{{r}_{b}}$$

is the dimensionless hatch spacing. In the combinations of processing parameters, 1/h* was kept at 2.0-3.0 and E* was kept at 1.7-4.3.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. An elastocaloric material comprising titanium-nickel based shape memory alloy having an adiabatic hysteresis area of about 15 MJ m⁻³ or less.

2. The elastocaloric material of claim 1 further comprising at least about 30%, preferably at least about 35% per volume of intermetallic phase.

3. The elastocaloric material of claim 2, wherein said intermetallic phase comprises TiNi₃.

4. The elastocaloric material of claim 1, wherein said elastocaloric material is stable for at least about 100,000 cycles.

5. The elastocaloric material of claim 1, wherein said elastocaloric material has ΔE/E of 10% or less.

6. The elastocaloric material of claim 1, wherein said elastocaloric material is a nanocomposite material.

7. The elastocaloric material of claim 1, wherein said elastocaloric material has an isothermal hysteresis area of about 10 MJ m⁻³ or less.

8. The elastocaloric material of claim 7, wherein a difference in adiabatic hysteresis and the isothermal hysteresis is about 5 MJ m⁻³ or less.

9. The elastocaloric material of claim 1, wherein said elastocaloric material has an effective modulus of at least about 70 GPa.

10. An elastocaloric material comprising a mixture of (i) from about 30% volume to about 70% volume of transforming titanium-nickel alloy and (ii) from about 70% volume to about 30% volume of non-transforming titanium-nickel intermetallic phase.

11. The elastocaloric material of claim 10, wherein said elastocaloric material has an adiabatic hysteresis of about 15 MJ M⁻³ or less.

12. The elastocaloric material of claim 10, wherein said elastocaloric material is stable for at least about 100,000 cycles.

13. The elastocaloric material of claim 10, wherein said elastocaloric material has ΔE/E of 10% or less.

14. A method for producing a low-hysteresis elastocaloric material comprising a first and a second metal shape memory alloy, said method comprising:
(a) producing a molten pool of a first metal and a second metal; and
(b) cooling the molten pool at a rate of at least about 500 K s⁻¹ to produce a low-hysteresis elastocaloric material.

15. The method of claim 14, wherein said first metal and said second metal comprise:
(a) titanium and nickel;
(b) titanium and niobium;
(c) titanium and tantalum;
(d) titanium and palladium;
(e) titanium and gold;
(f) nickel and aluminum;
(g) nickel and manganese; and
(h) iron and palladium.

16. The method of claim 14 further comprising the step of heat treating said low-hysteresis elastocaloric material.

17. The method of claim 16, wherein said step of heat treating comprises heating said low-hysteresis elastocaloric material at a temperature of at least about 650° C. (i.e., 923 K) for at least 3 hours.

18. The method of claim 14, wherein said molten pool of said first metal and said second metal is produced via a laser beam.

19. A cooling system comprising an elastocaloric material of claim 1 that is operatively coupled to a mechanical device, wherein:
when said mechanical device applies a stress to said elastocaloric material, heat generated by said elastocaloric material from said stress is released to one part of said cooling system, and
when said mechanical device releases said stress, said elastocaloric material absorbs heat from another part of said cooling system.

20. The cooling system of claim 19, wherein said elastocaloric material comprises a mixture of (i) from about 30% volume to about 70% volume of transforming titanium-nickel alloy and (ii) from about 70% volume to about 30% volume of non-transforming titanium-nickel intermetallic phase.
